(19) United States
(12) Patent Application Publication
(10) Pub. No.: US 2002/0046473 A1
(43) Pub. Date: Apr. 25, 2002

(54) Low cost hypobaric dehydrator

(76) Inventors: Philip A. Rutter, Canton, MN (US); Brandon L. Rutter, Canton, MN (US); Mark L. Shepard, Viola, WI (US)

Correspondence Address: MERCHANT & GOULD PC, P.O. BOX 2903, MINNEAPOLIS, MN, 55402-0903, US

(21) Appl. No.: 09/970,354

(22) Filed: Oct. 2, 2001

Related U.S. Application Data
(60) Provisional application No. 60/237,413, filed on Oct. 2, 2000.

(51) Int. Cl. F26B 13/30; F26B 19/00; F26B 25/06

(52) U.S. Cl. 34/201; 34/92

(57) ABSTRACT

A crop dehydrator is disclosed that includes a large hollow cylinder, openable at one or both ends, that is air-tight and connected to an air-pump or vacuum pump capable of maintaining a moderate vacuum in the cylinder. As the air is pumped out of the cylinder, the water in a crop in the chamber vaporizes and is pumped out of the cylinder.

### RELATED APPLICATIONS

This application claims priority of United States provisional application Ser. No. 60/237,413, filed Oct. 2, 2000.

### FIELD OF THE INVENTION

This application relates generally to dehydrators and more particularly to a vacuum dehydrator for crops and other moisture bearing material drying operations.

### BACKGROUND OF THE INVENTION

Loss of harvested crops to post harvest spoilage is very high throughout the world, but most particularly in the developing world where advanced dehydration technology is not available because of the high capital expense and the expense of fuel.

The United Nations Food and Agriculture Organization estimates of crop waste range from 0-10% in developed nations to 20-80%, and above, in developing nations. In general cereal spoilages are in the lower ranges, and other foodstuffs such as roots, tubers, and fruits in the higher ranges.

Grain dehydrators throughout the First World generally use large amounts of propane or similar fuel to heat air, which is then driven through the crop with high-powered electric fans. Crops are contained in special buildings during the drying, and transferred via electrically driven augers to other specialized storage facilities to await use.

All this technology is beyond the reach of developing villages. Throughout much of the tropical and subtropical areas of the world, crop storage continues to be carried out via ancient traditions, which are both highly labor intensive and limited in effectiveness; and often, available only during dry seasons. In many cases, the only resource remote developing populations have in abundance may be labor.

A tremendous amount of available grain, vegetables, and fruit in these areas spoils, or is simply allowed to spoil for lack of any way to store it. The result is an increased pressure on the environment, both crop land and forest, to produce additional needed food. A very great deal of environmental pressure could be relieved by finding ways to preserve and store existing food.

Correctly dried and stored foodstuffs can also be a critical source of cash income for developing areas. There is, in addition, a great deal of food currently produced in wet tropical areas which has simply never been traditionally collected for storage, because there has never been any workable storage process available. A great deal of fruit, vegetables, seeds, and grains which are available during rainy seasons is simply allowed to rot for lack of any means of preservation. The ability to store such foods could decrease pressures to clear existing forests and other ecosystems to provide new agricultural croplands.

There is therefore a need for a crop dehydrator that is inexpensive to build, inexpensive and simple to operate, and which can be powered by resources readily available in the place it is to be utilized.

### SUMMARY OF THE INVENTION

Against this backdrop the present invention has been developed. One embodiment of the present invention is simply a closable container for receiving a bulk crop material such as a length of culvert pipe with a wooden cap closing each end forming a drying chamber and a vacuum drawing means connected through one of the caps to the pipe interior operable to produce and maintain a vacuum within the container. The vacuum drawing means may be a commercially available vacuum pump or may simply be an internal combustion engine with its air cleaner removed and the air inlet to the engine cylinder(s) connected via pipe or rigid hose into the container through the cap. The engine then may be turned by hand or other motive means to draw a vacuum within the chamber. Such a vacuum will then draw moisture out of any crop material placed in the chamber, thus drying the crop material. The hypobaric dehydrator according to the present invention is primarily directed to drying crops such as corn and rice. However, the dehydrator may also be used to dry other crops and other moisture containing materials such as lumber.

Water is liquid between 0° and 100° C. at standard air pressure. The transition to a gas requires a considerable amount of energy under common conditions, beyond the 1 calorie of heat per gram need to raise the temperature of the water 1° C., the transition from liquid phase at 100° requires an additional 540 calories per gram of water; relative to other energy costs in the process, a huge amount. Essentially, the change to the gaseous state will be facilitated by either raising the temperature, or by decreasing the atmospheric pressure.

Freeze-drying is a dehydration process long commercialized, and is a hypobaric process. In this case, the substance being dried is first frozen, usually so that aromatic substances, e.g. the flavors in brewed coffee, will be preferentially retained in the dried product, while the somewhat more volatile water is pulled off by vacuum. Alternatively, the material being dried may be frozen to prevent decomposition during the drying process. Freeze-drying, however, is a technically demanding, high vacuum process; energetically quite expensive, and hence not appropriate for developing communities.

The hypobaric dehydrator in accordance with the present invention is intended to function primarily at ambient temperatures, and is not primarily intended for drying extremely perishable foodstuffs such as meat. Rather, it is intended to dry foodstuffs (and other materials) which may be dried successfully under ideal conditions, but which may easily spoil if the drying process is interrupted by a humid weather system or rain. Examples of such crops would be standard grains such as maize, rice, and wheat; chestnuts, and moderately acid fruits such as apples, apricots, and persimmons. Some chilling of the crop being dried will occur due to the hypobaric drying process, and may improve the quality of the final product in many cases.

Heating crops to dry them in fact drives off many volatile substances besides water. Hypobaric dehydration will do the same, but it can be expected that other substances being evaporated will not respond in exactly the same way to decreased pressure as they do to increased temperature. Expected differences include:

fragrances/odors/flavors may be less, or more, affected immediate nutrient availability may be affected, as the crop is not heated to the same extent. Some nutrients may be better preserved as a result of hypobaric dehydration, others may be less available due to less heat treatment.

Drying occurs when conditions are such that the partial pressure of water within a material is higher than the partial pressure of water in whatever surrounds the material, inducing movement of water out of the material. In current practices this is generally achieved by heating the material, increasing the vapor pressure of water in the material. The necessary pressure differential will also occur if the pressure of air around the material is reduced, thereby reducing the partial pressure of water outside the material. These methods can work separately or in concert.

In the hypobaric pathway, the heat of vaporization is supplied by the material and the material is thereby cooled. Once the material is cooled, its internal vapor pressure is decreased and a higher vacuum is required to draw off more water. In the present dehydrator, however, heat will also be supplied by the external environment once the dehydrator's internal temperature is below ambient. Although unnecessary, solar heating will obviously help a great deal here by reducing the amount of work necessary from the vacuum pump.

For a given amount of water, the same amount of energy is necessary to vaporize it regardless of the pathway. When a material is heated, however, there are usually large heat losses and a great deal of energy is spent heating the environment. In the hypobaric pathway, some of the energy used is actually heat drawn from the environment, and the amount of energy input supplied by the user is much less.

There is a high probability that the present reliance on heat to dry crops may be primarily an artifact of the development of such processes and machines in temperate regions, such as Europe and the USA, where ambient conditions at the time of harvest (autumn) are generally cool and somewhat dry. Spoilage under such conditions may be slow, and applying heat is both traditional and technically simpler than placing the crop to be dried into a container with decreased atmospheric pressure.

However, besides the present design of a hypobaric crop dehydrator specifically intended for developing communities with few resources, the hypobaric dehydration process according to the present invention will prove economically superior to dehydration using heat for many mainstream agricultural situations. The amount of energy required to dry the same materials using a controlled decrease of atmospheric pressure can be very considerably less than the energy needed using heat. The decreased use of fossil fuels to dry crops in developed nations could have important environmental and economic impacts.

Essentially, the fully assembled dehydrator consists of a large tubular body, openable at one or both ends, forming a chamber for holding the crop that is air-tight and connected to an air-pump capable of maintaining a moderate vacuum in the chamber. As the air is pumped out of the chamber, the water in the crop is the most available material that can vaporize and replace the lost air; as water vapor develops, it too is pumped out of the cylinder. These and various other features as well as advantages which characterize the present invention will be apparent from a reading of the following detailed description and a review of the associated drawings.

### BRIEF DESCRIPTION OF THE DRAWINGS

FIG. 1 is a simplified schematic view of a hypobaric crop dehydrator in accordance with a preferred embodiment of the present invention.

FIG. 2 is a perspective view of the hypobaric crop dehydrator of FIG. 1

### DETAILED DESCRIPTION

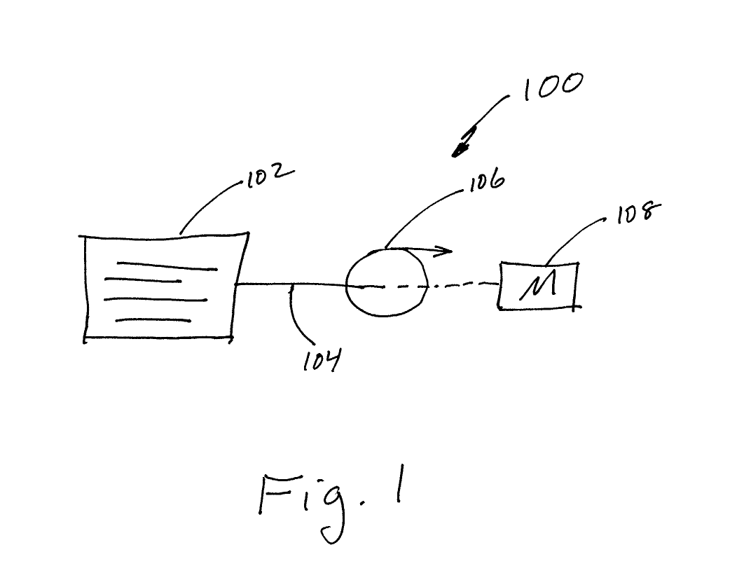

FIG. 1 is a schematic view of the dehydrator in accordance with the present invention. The hypobaric dehydrator 100 has a closable container 102 connected via a conduit 104 to a vacuum pump 106. The vacuum pump 106 is in turn connected to a motor 108.

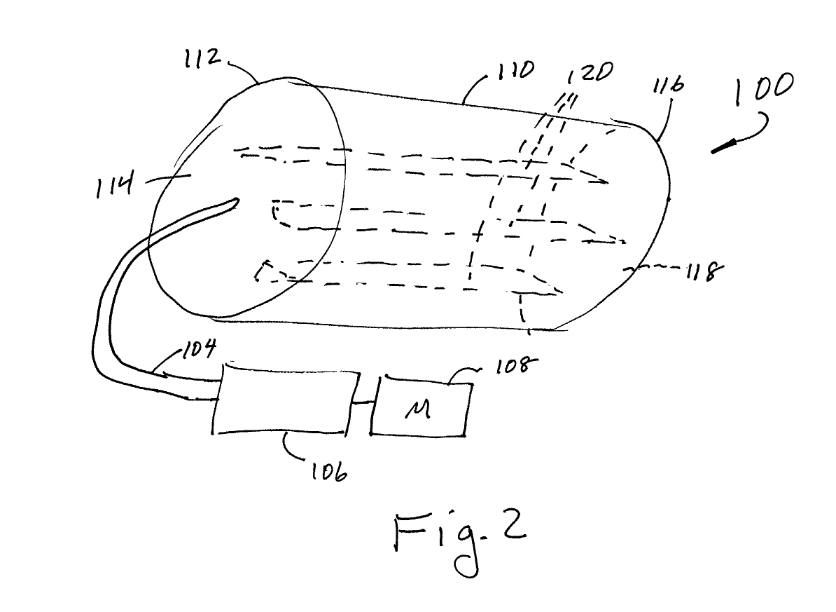

The closable container 102 may simply be a length of pipe or culvert 110 as shown in FIG. 2. One end 112 of the culvert 110 has a plywood cap 114 sealing the end 112. The other end 116 of the culvert 110 has another plywood cap 118 hinged to and sealing the end 116. The ends 112 and 116 must be fully sealed, if possible, to permit the vacuum pump 106 to draw a substantial vacuum within the container 102.

Each of the caps 114 and 118 may be hinged to the culvert 110 to conveniently provide access to the interior of the container 110. In one embodiment of the invention a 3-foot by 9-foot metal culvert has been used successfully. In this embodiment, the caps 114 and 118 were made of plywood painted to improve their sealing ability. Alternatively, preformed domed or hemispherical caps could be fabricated of polycarbonate or other high strength materials that would provide a better seal than plywood.

The conduit 104 may be plastic or metal pipe or hose such as a corrugated hose as well as any other circumferentially rigid tube material that can preferably withstand at least 15-20 inches Mercury vacuum without collapsing. The conduit 104 may be permanently or removably connected to one of the caps 114 and 118 with the other end connected to the vacuum pump. A simple vacuum cleaner hose may also be used for the conduit 104 if available.

Alternatively, the fully assembled dehydrator in accordance with the invention may be viewed as a large hollow cylinder, openable at one or both ends, that is air-tight and connected to an air-pump capable of maintaining a moderate vacuum in the cylinder. As the air is pumped out of the cylinder, the water in the crop is the most available material that can vaporize and replace the lost air; as water vapor develops, it too is pumped out of the cylinder.

In particular, the cylinder body may be composed of identical, modular sections, preferably half-cylindrical, but also possibly ¼ cylindrical. The modular sections have two different critical functions: a) each section is intended to be sufficiently lightweight that they could be carried, by human or draft animal means, into remote areas without adequate vehicular access; and b) the modular nature of the sections is intended to allow each user to build a dehydrator of the size appropriate for their particular use, which they can afford, which is easily repaired, and which they can enlarge at a future time without having to buy a new dehydrator. The preferred material for the modular sections is fiberglass; but corrugated aluminum, steel, polyethylene, or other materials may also be used. In all cases, the modular sections are constructed with integral reinforcing structures to resist implosion.

Quarter cylindrical sections would allow construction of a much larger dehydrator, given the design intention that each section should be portable; but would carry the penalty of causing many more seams in the dehydrator, i.e. potential leaks. The joint areas of each modular section are constructed so that when the interior of the assembled cylinder is at a lower air pressure than the outside, the joints are compressed, improving the air seal as the pressure differential increases. It is not necessary for the joints to be absolutely air-tight for the dehydrator to function efficiently. This may be achieved in fiberglass modules by making the lower lip of a joint structurally thicker and rigid, and the upper lip, on the adjoining module, thin and flexible. A compressible material is preferably placed into the joints during assembly of the dehydrator. For example, preferably uniform (butyl) rubber strips may be used. Alternatively, locally available clay or similar substance can be used to improve the sealing of the joints. A more complex version may be constructed around a rigid interior skeleton, against which the joints may be compressed when the interior of the dehydrator is under vacuum.

The ends of the dehydrator are preferably hinged doors, which may be opened to load and unload the materials being dried. The doors can contain safety valves to prevent accidental implosion in the event of extreme vacuum development, and manual valves with which to equalize internal and external pressure, so that the doors can be opened when the crop being dried needs attention.

The interior of the dehydrator chamber can be fitted with a variety of racks 120, which can accommodate different quantities and types of crops, so that the capacity of the dehydrator is maximized. The walls of the chamber can include reinforced sockets or ledges to accept rack feet or framework. It will be most efficient if the racks 120 are entirely removable from the dehydrator; in which case it will be possible to remove a set of racks 120 when their contents are dry, and immediately place an additional set of newly loaded racks 120 into the dehydrator. Thus the dehydrator can quickly continue to operate while the dried crop is handled and put into appropriate storage. Users can make their own racks 120 out of available materials. Likewise, the cradle structure needed to support the entire dehydrator can readily be made locally, using materials such as bamboo.

The preferred color of the dehydrator and/or modular sections and doors is flat black, both exterior and interior, to enhance solar heating and re-radiation of environmental heat into the drying crop. While solar heat input is not required for the dehydrator to function efficiently, any solar heat available will increase the speed with which the crop is dried. Ideally, the dehydrator should be as thermally conductive as possible, to improve heat transfer from the outside to the inside. In practice, fiberglass may be an adequate thermal conductor.

Any available source of vacuum may be attached to the dehydrator to make it function. Users having access to reliable electricity can use a variety of readily available air pumps. Gasoline or diesel driven pumps are also available. However, in many cases the factor which is most critical in making drying technologies unavailable to developing areas is the cost of the fuel required. Hence our preferred vacuum pump is mechanically driven, by any of a number of commonly available mechanisms, including water wheels, bicycle chain drive, or a gravity driven pulley mechanism similar to that used in a grandfather clock. That is; where appropriate, the dehydrator can be effectively operated with no purchased fuel required, and no reliance on unpredictable solar energy.

Because this dehydrator does not rely on a vapor pressure difference between the crop and the ambient air to effect the removal of water from the crop, the dehydrator will, in fact, function quite efficiently even during rainfall; thus crops will be dried effectively even during rainy seasons.

The dehydrator doors also preferably include a simple check valve that will allow airflow out of the dehydrator any time air pressure inside the dehydrator is greater than outside ambient air pressure. This will be of use in case of substantial solar heat gain, or in cases where the material being dried is loaded into the dehydrator when it is hot; for example freshly cooked grains or fruits scalded to provide surface sterilization and skin cracking to facilitate drying; a standard practice. In some environments, where solar input is substantial and reliable, these check valves alone may allow the dehydrator to operate adequately. During the day, the solar heat increases the water vapor pressure from the crop; when the dehydrator cools at night, the check valves will close, both prohibiting moisture movement back into the crop, and developing some vacuum within the dehydrator, depending on the amount of cooling, that will pull more water from the crop.

The simplest and cheapest vacuum pump for developing communities using these dehydrators in accordance with the present invention may be a modified one-cylinder four cycle internal combustion engine. Typically, such engines are readily available in developing areas, and it need not be in working order for the engine block to still function quite effectively as a vacuum pump. Multiple cylinder engine blocks could also be modified, but would require more work.

If the valves are removed or jammed open without interfering with cylinder movement, check valves can be installed at the intake and exhaust ports to allow air flow through the engine in only one direction. The resulting pump will work if the shaft is driven in either direction or even if the shaft is only oscillated through a partial revolution. An air filter will be necessary at some point between the material to be dried and the pump to prevent dust and insects from clogging the pump. It will be necessary to supply oil of some kind to the piston; if the engine block does not have an appropriate oil pump built in, oil can be provided by a drip from a reservoir connected to the engine through the sparkplug hole. When the upper reservoir is empty, the crankcase can be drained to refill it; standard motor oil is not necessary, though probably best; even vegetable oils could be made to serve. A translucent 2 liter soda pop bottle, for example, is universally available, and could easily be adapted to serve as the upper oil reservoir. The manufacturer could very inexpensively provide basic connections and a drip valve for such a reservoir.

Since the amount of force needed to drive the pump on the intake stroke will vary greatly depending on how much air and water vapor has been removed from the dehydration chamber, a two-stage method will be useful. One possible such method would be to use a spool and weighted line to turn the crank shaft, with a handle attached to the spool for manually driving the pump at low vacuum, either when the dehydrator has been newly loaded or possibly in strong sunshine, when the additional heat increases the rate of water vaporization. Once the shaft can no longer be turned by hand, the weight line can be wound to maintain a vacuum on the material being dried as it releases more water. Depending on the size of weight used, the weight line may also be used to pull more vacuum than can practically be done by hand.

In addition, spools of different sizes and diameters will prove useful. For early drying stages, a small diameter spool will provide adequate force to motivate the pump; for later stages, or to develop higher vacuum rates to finish drying, a large diameter spool can provide greater force to the pistons. Preferably, the adapted engine crank shaft will allow easy interchange of appropriate spools. Typically, the weight used can simply be a rock, or basket filled with smaller rocks to facilitate resetting. Preferably, the pump will be mounted on a raised platform beside the dehydrator, thereby lengthening the amount of time it can be left without rewrapping.

Other methods of driving the shaft can also be used where available, hydropower is one example. The air (vacuum) pump need not be mounted particularly close to the dehydrator in this instance, so long as a competent air line between the pump and the dehydrator can be provided.

An extremely simple drive for the engine could be provided by a pendulum of substantial mass. This could then be driven by hand simply by attaching a lever to the shaft. The pendulum shaft must be as rigid as possible; most likely steel, which may not be locally available; but the pendulum weight could again be made locally; for example by a basket of stones attached rigidly to the shaft. Also, as the pendulum slows, it will move considerably less air volume with each oscillation. The major advantage of a pendulum drive is its extreme simplicity of construction.

Massive flywheel drives are also possible, but considerably more complex to construct. They would need to be reasonably well balanced, and must be totally shielded from human contact. Ideally, such flywheels would be pumped by an easily adapted bicycle drive. Any bicycle drive must have a freewheeling feature, normally used to allow coasting with feet not moving, to prevent injury to bystanders. It will also be best if the bicycle drive used has multiple gears available. Once correctly constructed and shielded, anyone can mount the stationary bicycle and contribute speed to the flywheel. Most simply, such a flywheel could be adequately provided locally by acquiring an old truck wheel with a hub and tire. The tire could then be filled with concrete, through holes cut in the tire, which primarily serves as a form for the concrete. Balancing could be achieved by chiseling out concrete. Properly lubricated, balanced, and pumped, such a flywheel drive may be expected to operate the vacuum pump for as much as an hour or more without additional attention.

Non modular versions can of course also be built. In some situations it may be cheaper to modify a culvert, a pipe, or an existing tank, such as an old bulk propane storage cylinder.

Trial runs of a prototype of the present invention in China indicate faster drying is achieved if the vacuum in the drying chamber is not kept constant. That is, a slight leak of outside air, referred to as flow through vacuum, dries faster than constant stagnant vacuum. The presence of non-water gas molecules, to replace the water in the drying crop, may be necessary to allow additional water to escape. Preferably a sequence of alternating periods of applying vacuum followed by the introduction of air to the drying chamber, followed by repeated vacuum/air cycles, (punctuated vacuum) appear to dry the crop substantially faster than vacuum alone.

This raises another alternative in accordance with the present invention for accelerated, low cost dehydration. While large and consistent quantities of fuel may not be available in developing villages, hence making heating of the crop unreliable as a drying pathway, small and erratic supplies of any fuel can be useful in the present invention. A 55 gallon steel fuel drum will be universally available. Such a waste drum can be filled with calcium chloride nuggets, or some similar extremely hygroscopic, cheap substance. In the event that calcium chloride or another suitable substance is not available, filling the 55 gallon drum with 1-2 inch diameter river stones (so they will not pack) would provide an effective way to store heat and partially dry the air entering the dehydration chamber.

A system of air channels and valves can be provided in the drum air flow path, so that the dehydrator, during the air cycle, pulls its air through the drum. A small fire, using any waste fuel available, can be periodically built under the drum; both heating and drying the calcium chloride. This will provide the dehydrator with heated, dessicated air for the air cycle, dramatically increasing the speed of the process, and further increasing its ability to function in very high humidity environments where any crop drying is normally impossible.

It is always possible for the drum to be overheated; in such case the inclusion of one or more automotive cooling system thermostats could insure that air being pulled into the dehydrator is not excessively hot. The opening thermostat would allow the inhaling of unheated air.

The addition of an inhale cycle opens the door for a number of possibilities:

1) Fruit being dried may be treated with antioxident materials during the drying process and via the inhaled gas. A common practice in commercial fruit drying is to apply sulfite chemicals or chemicals such as ascorbic acid, to prevent oxidization of the fruit, with its accompanying darkening. Antioxidents keep the fruit fresh looking, and important aspect when being produced for sale.

Again, there are several possibilities here; it will be possible, when economic, to provide specific gases for the inhale cycle; for example pure N₂, which will not cause oxidization, and will prevent it by excluding O₂. And/or, specific antioxident chemicals can be vaporized and provided to the crop during the inhale cycle, resulting in thorough, uniform, and low labor application of such preservatives.

2) Other materials being dried, such as wood, could have preservatives or treatments of various types supplied to them during the inhale cycle; resulting in thorough, low labor treatment, with good penetration of the treatment chemicals, as they move in to fill the existing vacuum in the product.

It will be clear that the present invention is well adapted to attain the ends and advantages mentioned as well as those inherent therein. While a presently preferred embodiment has been described for purposes of this disclosure, various changes and modifications may be made which are well within the scope of the present invention. Numerous other changes may be made which will readily suggest themselves to those skilled in the art and which are encompassed in the spirit of the invention disclosed and as defined in the appended claims.

What is claimed is:

1. A dehydrator apparatus for drying bulk moisture containing materials comprising:
a generally tubular body having first and second ends;
a first end cap closing the first end;
a second removable end cap closing the second end, wherein the second cap is openable to permit insertion and removal of bulk moisture containing materials into the tubular body;
a vacuum means connected into the body for drawing a vacuum within the tubular body; and
a motor operably connected to the vacuum means.

2. The apparatus according to claim 1 wherein the tubular body is a culvert.

3. The apparatus according to claim 2 wherein the end caps are made of plywood.

4. The apparatus according to claim 1 wherein the vacuum means is an internal combustion engine connected into the body via a tube connected to an air intake on the engine.

5. The apparatus according to claim 1 further comprising a plurality of racks 120 in the chamber for holding the material being dried.
